(19) United States
(12) Patent Application Publication
(10) Pub. No.: US 2026/0360332 A1
(43) Pub. Date: Nov. 12, 2026

(54) AMBIENT LIGHT DETECTION CIRCUIT, DISPLAY PANEL, AND DISPLAY PANEL TESTING METHOD

(71) Applicant: HKC CORPORATION LIMITED, Shenzhen (CN)

(72) Inventors: Shilong JIANG, Shenzhen (CN); Lulin MA, Shenzhen (CN); Xiao LIANG, Shenzhen (CN); Junhao LUO, Shenzhen (CN); Jiewei LI, Shenzhen (CN)

(21) Appl. No.: 19/638,405

(22) Filed: Apr. 3, 2026

(30) Foreign Application Priority Data
May 8, 2025 (CN) 202510588827.7

(51) Int. Cl. G09G 3/36; G09G 3/00

(52) U.S. Cl. CPC G09G 3/3688; G09G 3/006; G09G 2310/08; G09G 2320/043; G09G 2330/021; G09G 2360/144

(57) ABSTRACT

The ambient light detection circuit includes: a first driving module configured to generate a first driving voltage; a photosensitive module configured to generate a first photosensitive current corresponding to a current environment under the action of the first driving voltage; a light-shielding module configured to generate a first reference current corresponding to a black state environment under the action of the first driving voltage; and a second driving module configured to generate a first photosensitive voltage and a first reference voltage respectively based on the first photosensitive current and the first reference current. In the present disclosure, the current generated by the light-shielding module is used as a reference basis for the photosensitive module. When photosensitive characteristics shift under the influence of component aging or high-temperature and high-humidity environments, an offset generated by the photosensitive module may be counteracted by an offset generated by the light-shielding module.

### CROSS-REFERENCE TO RELATED APPLICATIONS

This application claims priority to Chinese Application No. 202510588827.7, filed on May 8, 2025, the entire disclosure of which is hereby incorporated herein by reference.

### TECHNICAL FIELD

The present disclosure belongs to the technical field of display driving, and particularly to an ambient light detection circuit, a display panel, and a display panel testing method.

### BACKGROUND

In an ambient light detection technology, photosensitive elements (such as photoresistors, photodiodes, or photosensors) are commonly used to detect ambient light intensity and convert a light signal into an electrical signal for output. The electrical signal is then used by subsequent circuits for brightness adjustment or energy-saving control.

However, when the photosensitive elements are affected by device aging or high-temperature and high-humidity environments, photosensitive characteristics of the photosensitive elements may shift. This shift leads to a gradual decline in the accuracy of ambient light detection, making the photosensitive elements impossible to correctly perceive actual lighting conditions and thus affecting the reliability of brightness adjustment.

### SUMMARY

The present disclosure provides an ambient light detection circuit, a display panel, and a display panel testing method, solving a problem of low accuracy in ambient light detection under device aging or high-temperature and high-humidity environments.

In a first aspect, the present disclosure provides an ambient light detection circuit, including: a first driving module, configured to generate a first driving voltage; a photosensitive module, where a first terminal of the photosensitive module is connected to a first connection terminal of the first driving module, and the photosensitive module is configured to generate a first photosensitive current corresponding to a current environment under the action of the first driving voltage; a light-shielding module, where a first terminal of the light-shielding module is connected to a second connection terminal of the first driving module, and the light-shielding module is configured to generate a first reference current corresponding to a black state environment under the action of the first driving voltage; and a second driving module, where a first connection terminal of the second driving module is connected to a second terminal of the photosensitive module, and a second connection terminal of the second driving module is connected to a second terminal of the light-shielding module, and the second driving module is configured to generate a first photosensitive voltage and a first reference voltage corresponding to the first photosensitive current and the first reference current respectively based on the first photosensitive current and the first reference current, such that a subsequent-stage load obtains a light intensity corresponding to the current environment based on a difference between the first photosensitive voltage and the first reference voltage.

In a second aspect, the present disclosure provides a display panel, where the display area includes a pixel array and an ambient light detection circuit; where the ambient light detection circuit includes: a first driving module configured to generate a first driving voltage; a photosensitive module, a first terminal of the photosensitive module being connected to a first connection terminal of the first driving module, and the photosensitive module being configured to generate a first photosensitive current corresponding to a current environment under an action of the first driving voltage; a light-shielding module, a first terminal of the light-shielding module being connected to a second connection terminal of the first driving module, and the light-shielding module being configured to generate a first reference current corresponding to a black state environment under the action of the first driving voltage; and a second driving module, a first connection terminal of the second driving module being connected to a second terminal of the photosensitive module, a second connection terminal of the second driving module being connected to a second terminal of the light-shielding module, and the second driving module being configured to generate a first photosensitive voltage and a first reference voltage corresponding to the first photosensitive current and the first reference current respectively based on the first photosensitive current and the first reference current, such that a subsequent-stage load obtains a light intensity corresponding to the current environment based on a difference between the first photosensitive voltage and the first reference voltage; where the non-display area includes a microcontroller unit, electrically connected to the ambient light detection circuit, configured to calculate a voltage difference between the photosensitive voltage and the reference voltage output by the ambient light detection circuit, and further configured to obtain the light intensity corresponding to the current environment based on the voltage difference.

In a third aspect, the present disclosure provides a display panel testing method, applied to a display panel testing system, the testing system including an upper computer and a display panel, where the upper computer includes a central processing unit and a graphics card, and the display panel includes a display area and a non-display area, where the display area includes a pixel array and an ambient light detection circuit; where the ambient light detection circuit includes: a first driving module configured to generate a first driving voltage; a photosensitive module, a first terminal of the photosensitive module being connected to a first connection terminal of the first driving module, and the photosensitive module being configured to generate a first photosensitive current corresponding to a current environment under an action of the first driving voltage; a light-shielding module, a first terminal of the light-shielding module being connected to a second connection terminal of the first driving module, and the light-shielding module being configured to generate a first reference current corresponding to a black state environment under the action of the first driving voltage; and a second driving module, a first connection terminal of the second driving module being connected to a second terminal of the photosensitive module, a second connection terminal of the second driving module being connected to a second terminal of the light-shielding module, and the second driving module being configured to generate a first photosensitive voltage and a first reference voltage corresponding to the first photosensitive current and the first reference current respectively based on the first photosensitive current and the first reference current, such that a subsequent-stage load obtains a light intensity corresponding to the current environment based on a difference between the first photosensitive voltage and the first reference voltage; where the non-display area includes a microcontroller unit, electrically connected to the ambient light detection circuit, configured to calculate a voltage difference between a photosensitive voltage and a reference voltage output by the ambient light detection circuit, and further configured to obtain the light intensity corresponding to the current environment based on the voltage difference; where the display panel further includes a timing controller and a source driver, the microcontroller unit is electrically connected to the central processing unit, the central processing unit is further electrically connected to the graphics card, the graphics card is connected to the timing controller, the timing controller is connected to the source driver, and the source driver is electrically connected to the pixel array; where the display panel testing method includes: When a trigger signal sent by the microcontroller unit is received, the central processing unit sends a test instruction to the graphics card, causing the graphics card to send display data to the timing controller; the timing controller performs signal conversion on the display data, generates driving data, and then sends the driving data to the source driver; the source driver drives the pixel array to display the image based on the driving data; the ambient light detection circuit collects the photosensitive voltage and reference voltage corresponding to the current image; the microcontroller unit obtains the light intensity based on the photosensitive voltage and reference voltage, enabling the central processing unit to obtain a test result of the display panel based on the light intensity.

### BRIEF DESCRIPTION OF DRAWINGS

The drawings herein are incorporated into the specification and form a part thereof, illustrating embodiments in accordance with the present disclosure, and together with the specification, are used to explain the principle of the present disclosure. Apparently, the drawings described below are merely some embodiments of the present disclosure. For those of ordinary skill in the art, other drawings may also be obtained based on these drawings without making creative efforts.

FIG. 1 shows a schematic structural diagram of an ambient light detection circuit provided in an embodiment of the present disclosure.

FIG. 2 shows a schematic circuit diagram of a first ambient light detection circuit provided in an embodiment of the present disclosure.

FIG. 3 shows a schematic diagram of a current flow provided in an embodiment of the present disclosure.

FIG. 4 shows another schematic diagram of a current flow provided in an embodiment of the present disclosure.

FIG. 5 shows a schematic diagram of driving timing provided in an embodiment of the present disclosure.

FIG. 6 shows a schematic structural diagram of a second ambient light detection circuit provided in an embodiment of the present disclosure.

FIG. 7 shows a schematic structural diagram of a subsequent-stage load provided in an embodiment of the present disclosure.

FIG. 8 shows a schematic diagram of test connections in the related art.

FIG. 9 shows a schematic diagram of an arrangement of an ambient light detection circuit provided in an embodiment of the present disclosure.

FIG. 10 shows a schematic structural diagram of a display panel testing system provided in an embodiment of the present disclosure.

FIG. 11 shows a schematic flow diagram of a display panel testing method provided in an embodiment of the present disclosure.

### DETAILED DESCRIPTION OF THE EMBODIMENTS

The exemplary embodiments will now be described more comprehensively with reference to the accompanying drawings. However, the exemplary embodiments may be implemented in various forms and should not be construed as limited to the examples set forth herein; rather, these embodiments are provided so that the present disclosure will be more thorough and complete, and will fully convey the concept of the exemplary embodiments to those skilled in the art.

In addition, the described features, structures, or characteristics may be combined in any suitable manner in one or more embodiments. In the following description, numerous specific details are provided to give a thorough understanding of the embodiments of the present disclosure. However, those skilled in the art will recognize that the technical solutions of the present disclosure may be practiced without one or more of the specific details, or other methods, components, devices, steps, etc. may be used. In another cases, well-known methods, devices, implementations, or operations are not shown or described in detail to avoid obscuring aspects of the present disclosure.

The following further details the present disclosure in conjunction with the drawings and specific embodiments. It should be noted that the technical features described in the various embodiments of the present disclosure may be combined with one another as long as there is no conflict between them. The embodiments described below with reference to the accompanying drawings are exemplary and intended to explain the present disclosure, and should not be construed as limiting the scope of the present disclosure.

In a first aspect, the present disclosure provides an ambient light detection circuit 100 specifically including the following embodiments.

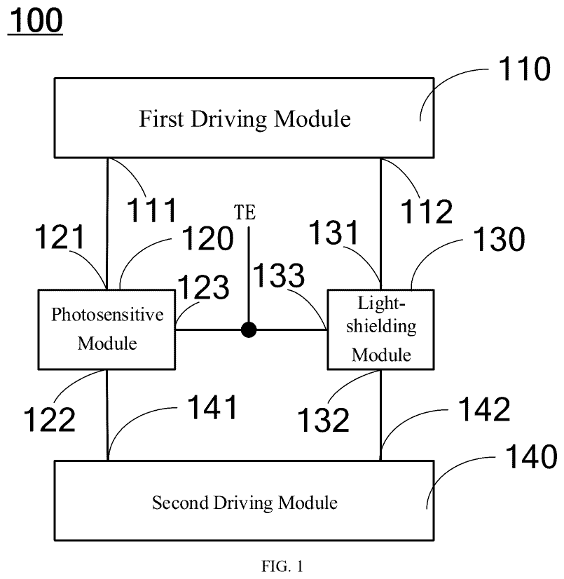

FIG. 1 shows a schematic structural diagram of an ambient light detection circuit provided in an embodiment of the present disclosure. As shown in FIG. 1, the ambient light detection circuit 100 may include a first driving module 110. The first driving module 110 is configured to generate a first driving voltage. A timing of the first driving voltage may be a square wave timing, that is, when ambient light intensity detection is required, the first driving voltage is at a high level, and when the ambient light intensity detection is not required, the first driving voltage is at a low level.

In this embodiment, the ambient light detection circuit 100 may further include a photosensitive module 120. A first terminal 121 of the photosensitive module 120 is connected to a first connection terminal 111 of the first driving module 110, and is configured to generate a first photosensitive current corresponding to the current environment under the action of the first driving voltage. Specifically, the photosensitive module 120 may include a photosensitive element. The photosensitive module 120 operates based on the principle that when photoelectrons are generated (i.e., when brightness changes occur), the photoelectrons are absorbed by an anode of the photosensitive element, thereby generating a current. As the light intensity increases, more photoelectrons are generated, and the photocurrent increases accordingly, allowing the light intensity to be calculated based on the photosensitive current. In this embodiment, when the first driving voltage is at a high level, the photosensitive module 120 generates the photosensitive current, and the magnitude of the photosensitive current varies based on different environments.

In this embodiment, the ambient light detection circuit 100 may further include a light-shielding module 130. A first terminal 131 of the light-shielding module 130 is connected to a second connection terminal 112 of the first driving module 110, and is configured to generate a reference current corresponding to a black state environment under the action of the first driving voltage. Specifically, the light-shielding module 130 shares the same operating principle, device model, and manufacturing process with the photosensitive module 120. The difference between the light-shielding module 130 and the photosensitive module 120 lies in that the photosensitive module 120 operates in a normal environment with illumination, while the light-shielding module 130 operates in a black state environment without illumination. The light-shielding module 130 may be implemented by providing a light-shielding housing on a surface of the photosensitive module 120, such that when the first driving voltage is at a high level, the light-shielding module 130 generates a first reference current corresponding to the black state environment. It may be known that the light-shielding module 130 shares the same device process, device model, operating principle, overall environment, and aging degree with the photosensitive module 120. Even if there is a photosensitive characteristic shift in the photosensitive device, both the light-shielding module 130 and the photosensitive module 120 shift in the same direction, allowing an offset of the light-shielding module 130 to counteract an offset of the photosensitive module 120.

In this embodiment, the ambient light detection circuit may 100 further include a second driving module 140. A first connection terminal 141 of the second driving module 140 is connected to a second terminal 122 of the photosensitive module 120, and a second connection terminal 142 of the second driving module 140 is connected to the second terminal 132 of the light-shielding module 130. The second driving module 140 is configured to generate a first photosensitive voltage and a first reference voltage corresponding to the first photosensitive current and the first reference current according to the first photosensitive current and the first reference current, respectively, allowing the subsequent-stage load 160 to obtain the light intensity corresponding to the current environment based on the difference between the first photosensitive voltage and the first reference voltage.

It should be noted that the second driving module 140 is also connected to the subsequent-stage load 160. After converting the received first photosensitive current and first reference current into the first photosensitive voltage and first reference voltage, the second driving module 140 outputs the first photosensitive voltage and first reference voltage to the subsequent-stage load 160, enabling the subsequent-stage load 160 to obtain the current light intensity corresponding to the current environment based on the voltage difference between the first photosensitive voltage and the first reference voltage. The subsequent-stage load 160 may be a control chip, a processing chip, a microcontroller unit, or another module with a computational function.

In summary, the photosensitive module 120 and the light-shielding module 130 in the present disclosure, under the action of the first driving voltage output by the first driving module 110, respectively generate the first photosensitive current corresponding to the current environment and the first reference current corresponding to the black state environment. Then, the second driving module 140 converts the first photosensitive current and the first reference current into the first photosensitive voltage and the first reference voltage corresponding to the first photosensitive current and the first reference current, allowing the subsequent-stage load 160 to calculate the light intensity corresponding to the current environment based on the difference between the first photosensitive voltage and the first reference voltage. Therefore, the present disclosure uses the current generated by the light-shielding module 130 as the reference basis for the photosensitive module 120. When photosensitive characteristic shifts occur due to component aging or high-temperature and high-humidity environments, the offset generated by the photosensitive module 120 may be counteracted by the offset generated by the light-shielding module 130, thereby improving the accuracy of ambient light detection.

In another embodiment, the second driving module 140 is further configured to generate a second driving voltage, such that the photosensitive module 120 is further configured to generate a second photosensitive current corresponding to the current environment under the action of the second driving voltage, and the light-shielding module 130 is further configured to generate a second reference current corresponding to a black state environment under the action of the second driving voltage. The first driving module 110 is further configured to generate a second photosensitive voltage and a second reference voltage corresponding to the second photosensitive current and the second reference current according to the second photosensitive current and the second reference current, respectively, allowing the subsequent-stage load 160 to obtain the light intensity corresponding to the current environment based on the difference between the second photosensitive voltage and the second reference voltage.

It should be noted that the first driving voltage and the second driving voltage may be driving voltages with the same voltage value. The first driving module 110 and the second driving module 140 in this embodiment do not simultaneously generate the first driving voltage and the second driving voltage. That is, when the first driving module 110 generates the first driving voltage, the second driving module 140 does not generate the second driving voltage; and when the second driving module 140 generates the second driving voltage, the first driving module 110 does not generate the first driving voltage.

Specifically, when the first driving module 110 generates the first driving voltage, the photosensitive module 120 generates the first photosensitive current corresponding to the current environment under the action of the first driving voltage, and the light-shielding module 130 also generates the first reference current corresponding to the black state environment under the action of the first driving voltage. When the second driving module 140 generates the second driving voltage, the photosensitive module 120 generates the second photosensitive current corresponding to the current environment under the action of the second driving voltage, and the light-shielding module 130 also generates the second reference current corresponding to the black state environment under the action of the second driving voltage. The magnitudes of the first photosensitive current and the second photosensitive current may be the same, but the current directions of the first photosensitive current and the second photosensitive current are required to be opposite. The first photosensitive current flows from the first terminal 121 of the photosensitive module 120 to the second terminal 122 of the photosensitive module 120. The second photosensitive current flows from the second terminal 122 of the photosensitive module 120 to the first terminal 121 of the photosensitive module 120. In addition, the magnitudes of the first reference current and the second reference current may be the same, but the current directions the first reference current and the second reference current are also required to be opposite. The first reference current flows from the first terminal 131 of the light-shielding module 130 to the second terminal 132 of the light-shielding module 130. The second reference current flows from the second terminal 132 of the light-shielding module 130 to the first terminal 131 of the light-shielding module 130. Therefore, the first driving module 110 and the second driving module 140 may control the direction of current generation in the photosensitive module 120 and the direction of current generation in the light-shielding module 130 to switch between forward and reverse, preventing the current generated by the photosensitive module 120 from remaining in the same direction and the current generated by the light-shielding module 130 from remaining in the same direction for extended periods, effectively preventing aging of the photosensitive module 120 and the light-shielding device, thereby prolonging the service life and improving the detection accuracy.

In another embodiment, as shown in FIG. 1, a control terminal 123 of the photosensitive module 120 is connected to an external enable terminal TE, and is configured to generate a photosensitive current corresponding to the current environment under the control of the enable signal output by the external enable terminal TE, based on the first driving voltage or the second driving voltage. The control terminal 133 of the light-shielding module 130 is connected to the external enable terminal TE, and is configured to generate a reference current corresponding to the black state environment under the control of the enable signal output by the external enable terminal TE, based on the first driving voltage or the second driving voltage.

It should be noted that when the enable signal output by the external enable terminal TE is at a high level, the photosensitive module 120 and the light-shielding module 130 are controlled to operate simultaneously: that is, the photosensitive module 120 is controlled to generate an induction current corresponding to the current environment, and the light-shielding module 130 is controlled to generate a reference current corresponding to the black state environment. When the enable signal output by the external enable terminal TE is at a low level, both the photosensitive module 120 and the light-shielding module 130 are controlled to shut down simultaneously: that is, both the photosensitive module 120 and the light-shielding module 130 are controlled not to generate any current. Therefore, in this embodiment, the enable signal output by the external enable terminal TE may control the simultaneous operation and simultaneous shutdown of the photosensitive module 120 and the light-shielding module 130, preventing the photosensitive module 120 and the light-shielding module 130 from remaining in an operating state continuously, thereby reducing the power consumption and prolonging the service life of the photosensitive module 120 and the light-shielding module 130.

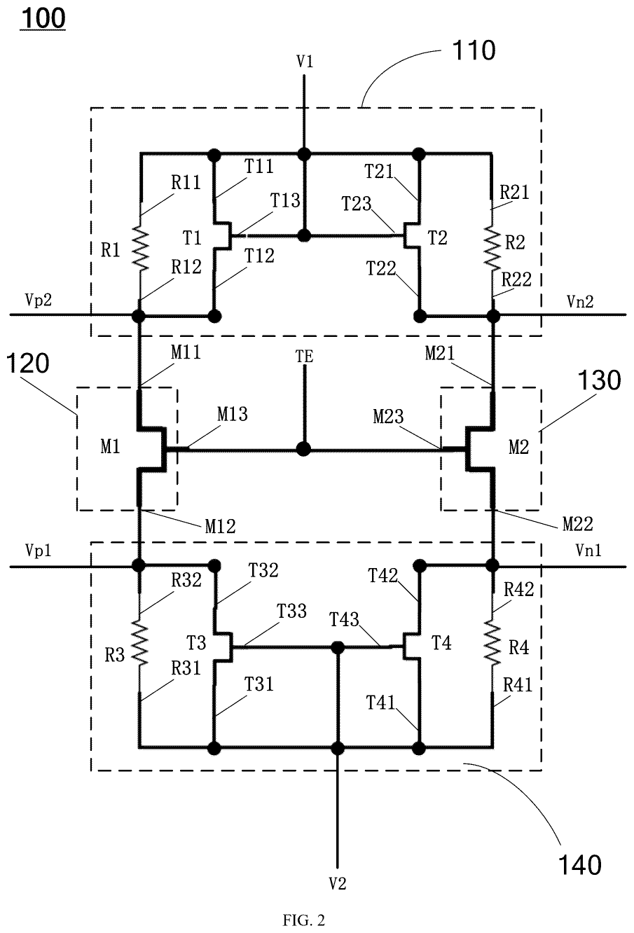

FIG. 2 shows a circuit schematic diagram of a first ambient light detection circuit provided in an embodiment of the present disclosure. As shown in FIG. 2, the photosensitive module 120 may include: a first photosensitive transistor M1. A control terminal M13 of the first photosensitive transistor M1 is connected to the external enable terminal TE. A first terminal M11 of the first photosensitive transistor M1 is connected to the first connection terminal 111 of the first driving module 110. A second terminal M12 of the first photosensitive transistor M1 is connected to the first connection terminal 141 of the second driving module 140.

In this embodiment, the light-shielding module 130 may include: a second photosensitive transistor M2. A control terminal M23 of the second photosensitive transistor M2 is connected to the external enable terminal TE. A first terminal M21 of the second photosensitive transistor M2 is connected to the second connection terminal 112 of the first driving module 110. A second terminal M22 of the second photosensitive transistor M2 is connected to the second connection terminal 142 of the second driving module 140.

It should be noted that, to reduce errors caused by transistor process differences, the first photosensitive transistor M1 and the second photosensitive transistor M2 in this embodiment have the same model, size, and function. The difference between the first photosensitive transistor M1 and the second photosensitive transistor M2 lies in that the first photosensitive transistor M1 is located in a photosensitive area with ambient light, and the second photosensitive transistor M2 is located in a shading area without the ambient light. The second photosensitive transistor M2 may be implemented by providing a light-shielding housing on the basis of the first photosensitive transistor M1, such that the second photosensitive transistor M2 continuously generates the reference current corresponding to the black state environment. In addition, the function of the second photosensitive transistor M2 is to provide the reference current for the first photosensitive transistor M1 under the black state environment. Compared with the conventional method of using a fixed reference current, this embodiment may correct the photosensitive characteristic shift of the photosensitive transistor under aging or high-temperature and high-humidity conditions.

As shown in FIG. 2, the first driving module 110 may include a first transistor T1, a first resistor R1, a second transistor T2, and a second resistor R2. Specifically, the control terminal T13 of the first transistor T1 is connected to the first power terminal V1, and a first terminal T11 of the first transistor T1 is connected to the control terminal T13 of the first transistor T1. A first terminal R11 of the first resistor R1 is connected to the first terminal T11 of the first transistor T1, and a second terminal R12 of the first resistor R1 is connected to a second terminal T12 of the first transistor T1. A control terminal T23 of the second transistor T2 is connected to the first power terminal V1, and a first terminal T21 of the second transistor T2 is connected to the control terminal T23 of the second transistor T2. A first terminal R21 of the second resistor R2 is connected to the first terminal T21 of the second transistor T2, and a second terminal R22 of the second resistor R2 is connected to a second terminal T22 of the second transistor T2. The second terminal T12 of the first transistor T1 serves as the first connection terminal 111 of the first driving module 110, and the second terminal T22 of the second transistor T2 serves as the second connection terminal 112 of the first driving module 110.

As shown in FIG. 2, the second driving module 140 may include a third transistor T3, a third resistor R3, a fourth transistor T4, and a fourth resistor R4. Specifically, a control terminal T33 of the third transistor T3 is connected to a second power terminal V2, and a first terminal T31 of the third transistor T3 is connected to the control terminal T33 of the third transistor T3. A first terminal R31 of the third resistor R3 is connected to the first terminal T31 of the third transistor T3, and a second terminal R32 of the third resistor R3 is connected to a second terminal T32 of the third transistor T3. A control terminal T43 of the fourth transistor T4 is connected to the second power terminal V2, and a first terminal T41 of the fourth transistor T4 is connected to the control terminal T43 of the fourth transistor T4. A first terminal R41 of the fourth resistor R4 is connected to the first terminal T41 of the fourth transistor T4, and a second terminal R42 of the fourth resistor R4 is connected to a second terminal T42 of the fourth transistor T4. The first terminal T31 of the third transistor T3 serves as the first connection terminal 141 of the second driving module 140, and the first terminal T41 of the fourth transistor T4 serves as the second connection terminal 142 of the second driving module 140.

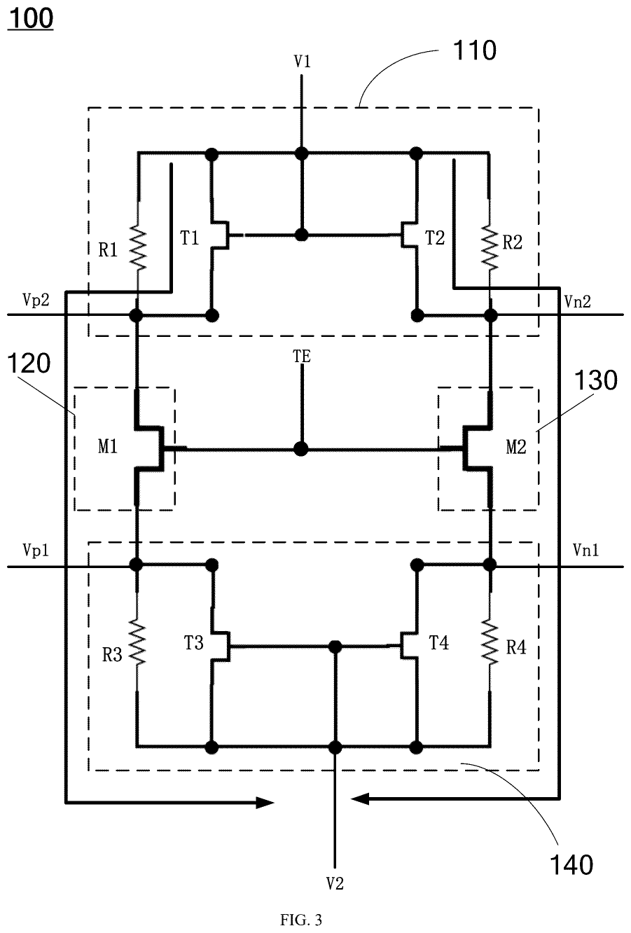

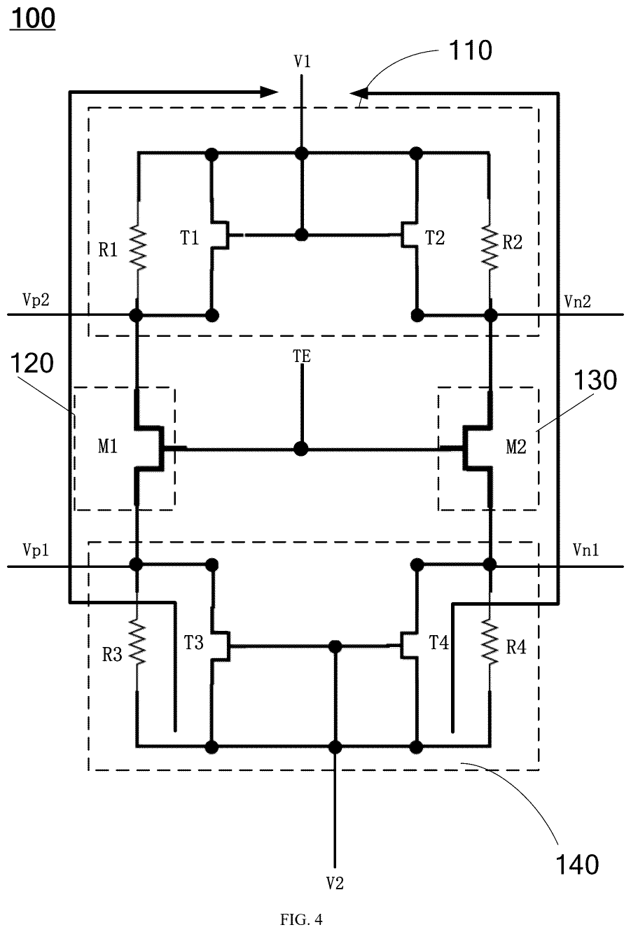

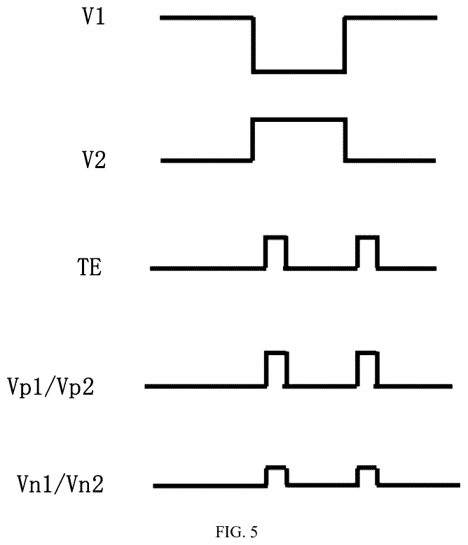

Based on the specific circuit structures of the first driving module 110 and the second driving module 140, the operating principle of the ambient light detection circuit 100 is explained in detail below in conjunction with the timing diagram of FIG. 5:
(1) When the external enable terminal TE starts outputting regular pulse enable signals, the first photosensitive transistor M1 and the second photosensitive transistor M2 are turned on to begin to acquire illumination data.
(2) When the first power terminal V1 outputs a high level and the second power terminal V2 outputs a low level (the low level may be a ground signal), the first transistor T1 and the second transistor T2 are turned on, while the third transistor T3 and the fourth transistor T4 are turned off. The voltage direction is from high potential to low potential, i.e., in a direction of a potential drop. As shown in FIG. 3, the electrical signal passes through the first transistor T1 and second transistor T2 above, then to the first photosensitive transistor M1 and second photosensitive transistor M2, and finally flows out from both sides of the third resistor R3 and fourth resistor R4 below. Therefore, the voltage at the first terminal of the third resistor R3 is the first photosensitive voltage, and the voltage at the first terminal of the fourth resistor R4 is the first reference voltage; the first terminal R31 of the third resistor R3 serves as the first photosensitive voltage output terminal Vp1, and the first terminal R41 of the fourth resistor R4 serves as the first reference voltage output terminal Vn1. The first photosensitive transistor M1 converts an optical signal into an electrical signal, enabling the subsequent-stage load 160 to determine the ambient light intensity corresponding to the current environment by referencing the voltage difference between the first photosensitive voltage and the first reference voltage, for example, through a lookup table.
(3) When the second power terminal V2 outputs a high level and the first power terminal V1 outputs a low level (the low level may be a ground signal), the third transistor T3 and the fourth transistor T4 are turned on, while the first transistor T1 and the second transistor T2 are turned off. The direction of voltage is from high potential to low potential, i.e., in a direction of a potential drop, as shown in FIG. 4. The electrical signal passes through the third transistor T3 and the fourth transistor T4 below, then to the first photosensitive transistor M1 and second photosensitive transistor M2, and finally flows out from both sides of the first resistor R1 and second resistor R2 above. Therefore, the voltage at the second terminal R12 of the first resistor R1 is the second photosensitive voltage, and the voltage at the second terminal R22 of the second resistor R2 is the second reference voltage; the second terminal of the first resistor R1 serves as the second photosensitive voltage output terminal Vp2, and the second terminal of the second resistor R2 serves as the second reference voltage output terminal Vn2. The first photosensitive transistor M1 converts an optical signal into an electrical signal, enabling the subsequent-stage load 160 to determine the ambient light intensity corresponding to the current environment by referencing the voltage difference between the second photosensitive voltage and the second reference voltage, for example, through a lookup table.

It may thus be seen that in this embodiment, the function of the first resistor R1, the second resistor R2, the third resistor R3, and the fourth resistor R4 is to convert the current signal into a voltage signal and output the voltage signal to the subsequent-stage load 160.

During the inventive process, the inventors of the present disclosure have discovered that the ambient light detection circuit 100 in the above embodiment has the first photosensitive voltage output terminal Vp1, the second photosensitive voltage output terminal Vp2, the first reference voltage output terminal Vn1, and the second reference voltage output terminal Vn2, i.e., a total of four voltage output terminals. This results in an excessive number of output terminals, affecting the connection to the subsequent-stage load 160.

To solve the above problem of too many output terminals, the present disclosure further provides another ambient light detection circuit 100 specifically including the following embodiments:

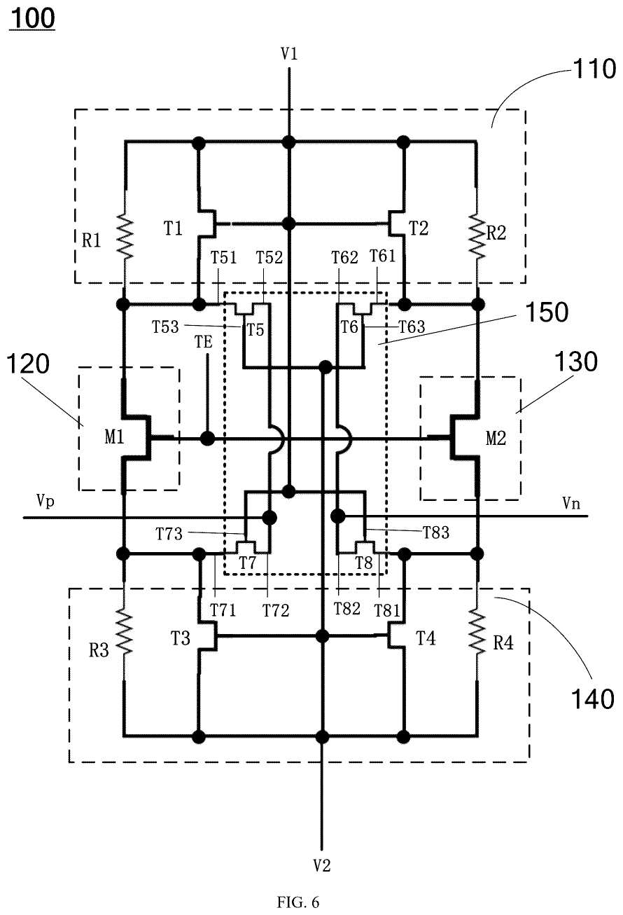

FIG. 6 shows a schematic structural diagram of a second ambient light detection circuit 100 provided in an embodiment of the present disclosure. As shown in FIG. 6, based on FIG. 2, the ambient light detection circuit 100 may further include: an output module 150. The output module 150 is respectively connected to the first driving module 110, the second driving module 140, and the subsequent-stage load 160, is configured to output the first photosensitive voltage and/or the second photosensitive voltage to the subsequent-stage load 160, and is further configured to output the first reference voltage and/or the second reference voltage to the subsequent-stage load 160.

As shown in FIG. 6, the output module 150 may include: a fifth transistor T5, a sixth transistor T6, a seventh transistor T7, and an eighth transistor T8. Specifically, a control terminal T53 of the fifth transistor T5 is connected to the second power terminal V2, and a first terminal T51 of the fifth transistor T5 is connected to the second terminal T12 of the first transistor T1; a control terminal T63 of the sixth transistor T6 is connected to the control terminal T53 of the fifth transistor T5, and a first terminal T61 of the sixth transistor T6 is connected to the second terminal T22 of the second transistor T2; a control terminal T73 of the seventh transistor T7 is connected to the first power terminal V1, and a first terminal T71 of the seventh transistor T7 is connected to the second terminal T32 of the third transistor T3, while a second terminal T72 of the seventh transistor T7 is connected to a second terminal T52 of the fifth transistor T5; a control terminal T83 of the eighth transistor T8 is connected to the control terminal T73 of the seventh transistor T7, and a first terminal T81 of the eighth transistor T8 is connected to the second terminal T42 of the fourth transistor T4, while a second terminal T82 of the eighth transistor T8 is connected to a second terminal T62 of the sixth transistor T6. The second terminal T72 of the seventh transistor T7 serves as the photosensitive voltage output terminal Vp, and is configured to output the first photosensitive voltage and/or the second photosensitive voltage; the second terminal T82 of the eighth transistor T8 serves as the reference voltage output terminal Vn, and is configured to output the first reference voltage and/or the second reference voltage.

It should be noted that the specific operating principle of the output module 150 in this embodiment is as follows:
(1) When the first power terminal V1 outputs a high level and the second power terminal V2 outputs a low level, the fifth transistor T5 and the sixth transistor T6 are turned off, while the seventh transistor T7 and the eighth transistor T8 are turned on. At this time, the voltage output from the photosensitive voltage output terminal Vp is the first photosensitive voltage, and the voltage output from the reference voltage output terminal Vn is the first reference voltage.
(2) When the second power terminal V2 outputs a high level and the first power terminal V1 outputs a low level, the fifth transistor T5 and the sixth transistor T6 are turned on, while the seventh transistor T7 and the eighth transistor T8 are turned off. At this time, the voltage output from the photosensitive voltage output terminal Vp is the second photosensitive voltage, and the voltage output from the reference voltage output terminal Vn is the second reference voltage.

Thus, this embodiment reduces the number of output terminals of the ambient light detection circuit from four to two by means of the output module, thereby lowering the requirement for the number of receiving terminals on the subsequent-stage load 160 and expanding the application scenarios for the ambient light detection circuit 100.

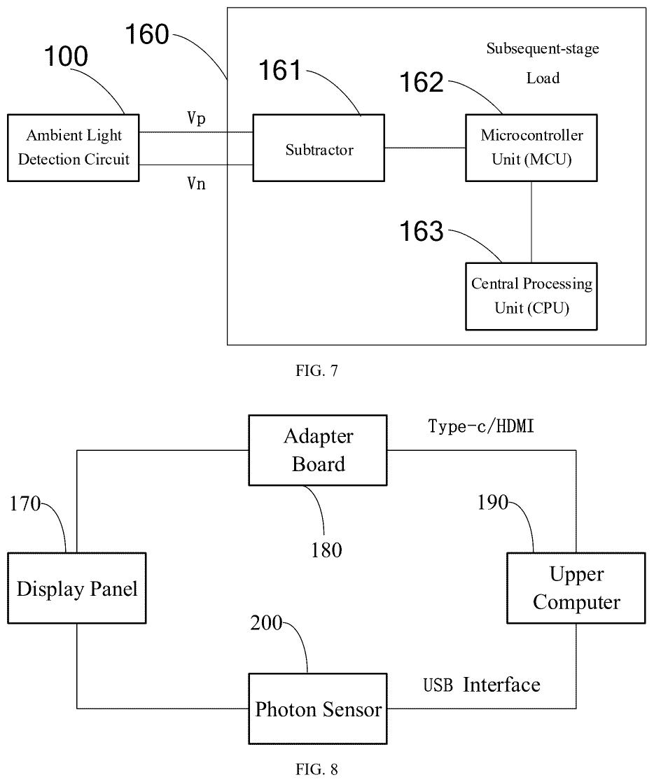

FIG. 7 shows a schematic structural diagram of a subsequent-stage load provided in an embodiment of the present disclosure. As shown in FIG. 7, the subsequent-stage load 160 provided in this embodiment may include, but is not limited to, a subtractor 161, a microcontroller unit (MCU) 162, and a central processing unit (CPU) 163. The ambient light detection circuit 100 sends the detected photosensitive voltage and reference voltage to the subtractor 161, and the subtractor 161 performs subtraction on the photosensitive voltage and reference voltage. The resulting difference voltage is then sent to the MCU 162 for further data analysis and processing, and finally, the calculated light intensity is output to the CPU 163.

In the MCU 162, the voltage corresponding to the maximum white state brightness (Lum_white) is set as data_white, the voltage corresponding to the reference black state brightness (Lum_black) is set as data_n, and the voltage corresponding to the current brightness is set as data_p. Therefore, the brightness corresponding to the current display image equals [(data_p−data_n)×Lum_white]/(data_white−data_n); for example, the maximum white state brightness written in the extended display identification data (EDID) is 300 nits, corresponding to a voltage of 5.2V. The black state brightness is 0.3 nits, corresponding to a voltage of 0.2V. If the current voltage is 3.2V, then the corresponding brightness equals [(3.2V−0.2V)×300 nits]/(5.2V−0.2V)=180 nits.

In another embodiment, the MCU 162 may include a difference calculation function of the subtractor 161, enabling the MCU 162 to directly process the photosensitive voltage and reference voltage output by the ambient light detection circuit 100, so as to obtain the corresponding light intensity.

In a second aspect, the present disclosure provides a display panel 170, specifically including the following embodiments:

Currently, the liquid crystal display (LCD) technology has become standardized in terms of daily display and basic functions. For example, in familiar industrial control, maintenance markets, or cost-reduction products, many customers opt for displays with richer features, especially in the notebook market. To gain a more advantageous position in the market, various advanced technologies have already been applied to notebooks on the functional side, such as AMD Freesync (gaming intelligent display technology), an OverDrive Function (OD Function), and a dynamic dimming system (DDS). In testing these technologies, each one utilizes a photon sensor 200 or an ambient light detection circuit 100 as a test tool. As shown in FIG. 8, an upper computer 190 is connected to a photon sensor 200 via a USB interface, and the photon sensor 200 acquires the ambient light intensity around the display panel 170. The upper computer 190 then generates a corresponding test signal based on the acquired light intensity and sends the corresponding test signal to an adapter board 180 via a Type-C or HDMI interface, enabling the adapter board 180 to light up the display panel 170 according to the corresponding test signal.

However, different upper computers 190 are equipped with CPU chips from various manufacturers, and each CPU chip manufacturer has its own corresponding photon sensor 200. As a result, there are several issues in testing the optical data of display panels. (1) Fragmentation of test tools: Different chip suppliers require proprietary photon sensor devices thereof, leading to frequent hardware switching during the testing process. (2) Low operational efficiency: The steps to connect external photon sensors are cumbersome, increasing the testing time and complexity. (3) Insufficient system integration: There is no deep integration between the test module and the display panel, making standardized and integrated optical testing difficult to achieve.

Therefore, to solve the above problems, the present disclosure provides a display panel 170 including a display area 1710 and a non-display area 1720. The display area 1710 may include a pixel array 173 and at least one ambient light detection circuit 100 as described in the above embodiments. The non-display area 1720 may include a microcontroller unit 162 electrically connected to the ambient light detection circuit 100, and configured to calculate a voltage difference between the photosensitive voltage and the reference voltage output by the ambient light detection circuit 100, and further configured to obtain the ambient light intensity corresponding to the current environment based on this voltage difference.

In this embodiment, by integrating the ambient light detection circuit 100 within the display panel 170, relevant optical data may be tested directly by connecting to the upper computer 190, thus avoiding the issues of prolonged operation time and complicated steps caused by using different photon sensors 200 during testing.

It should also be noted that the first resistor R1, the second resistor R2, the third resistor R3, and the fourth resistor R4 in the ambient light detection circuit may be replaced with wires with equivalent resistance values. For voltage input selection, the output signals at the first power terminal V1 and the second power terminal V2 may be replaced with commonly used voltages on the display panel 170, such as a gate high voltage (VGH) and a gate low voltage (VGL). The enable signal output by the external enable terminal TE may also be replaced with a regular pulse signal, such as Start The Vertical sync (STV) (frame start signal).

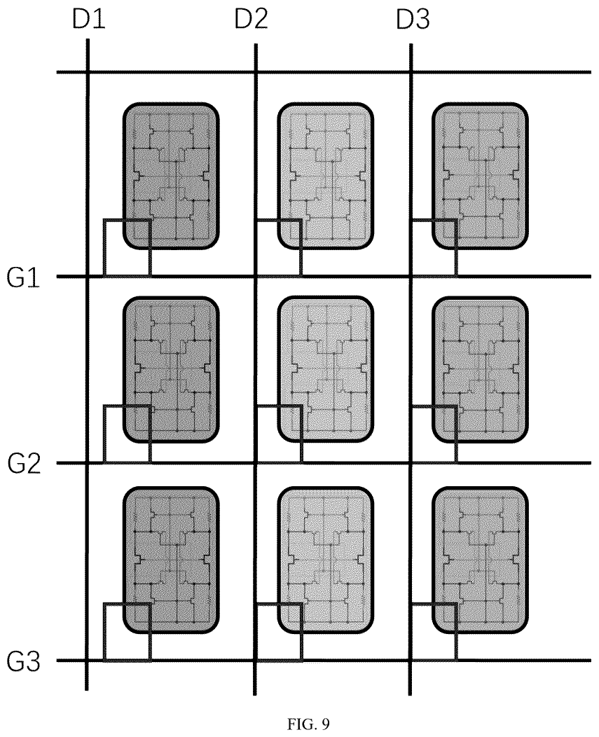

The ambient light detection circuit 100 in this embodiment not only measures the current brightness of the display panel 170, but may also be placed within sub-pixels to test the color coordinates of pixels. As shown in FIG. 9, an ambient light detection circuit 100 is placed for each R/G/B sub-pixel, since the photosensitive voltage and brightness presented for each sub-pixel differ for different colors. For example, if white is displayed, R/G/B are all lit simultaneously, and the data for R/G/B is required to be processed separately, then integrated by the microcontroller unit (MCU) 162 to obtain the color coordinates under the white screen. If red is displayed, the data for G/B is zero, so only the data for R is required to be processed.

In FIG. 9, three sets of R/G/B ambient light detection circuits 100 are placed. By setting up control groups in this way, three sets of data corresponding to the three sets of R/G/B ambient light detection circuits 100 may be averaged, making the obtained color coordinates more accurate and avoiding measurement errors. By processing the voltage data of each sub-pixel with the MCU 162, the color coordinates corresponding to the current color may be obtained.

In a third aspect, the present disclosure provides a display panel testing method, specifically including the following embodiments.

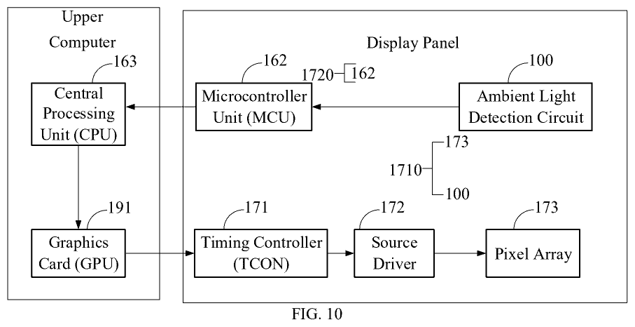

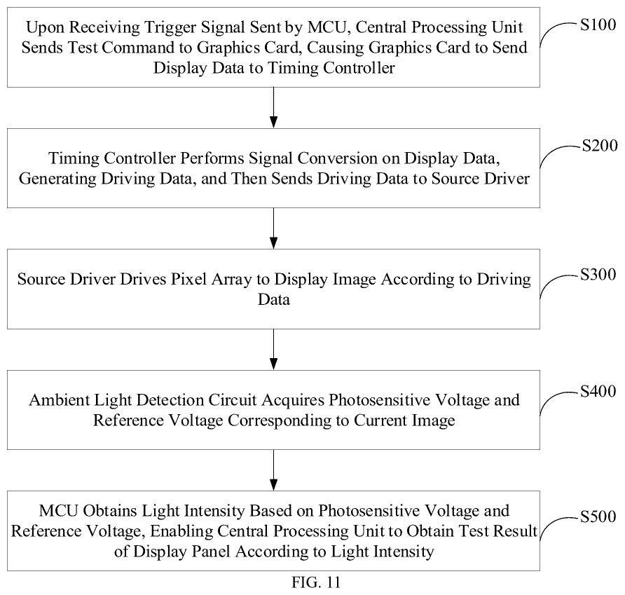

FIG. 10 shows a schematic structural diagram of a display panel testing system provided in an embodiment of the present disclosure. As shown in FIG. 10, the display panel testing system may include an upper computer 190 and the display panel 170 described in the above embodiments. The upper computer 190 may include a central processing unit 163 and a graphics card 191. The display panel 170 may further include a timing controller 171 and a source driver 172. The MCU 162 is electrically connected to the central processing unit 163, and the central processing unit 163 is also electrically connected to the graphics card 191. The graphics card 191 is connected to the timing controller 171. The timing controller 171 is connected to the source driver 172, and the source driver 172 is electrically connected to the pixel array 173.

FIG. 11 shows a flowchart of a display panel testing method provided in an embodiment of the present disclosure. As shown in FIG. 11, the display panel testing method specifically includes the following steps.

Step S100: Upon receiving a trigger signal sent by the MCU, the central processing unit sends a test command to the graphics card, causing the graphics card to send display data to the timing controller.

Specifically, at the start of testing, the MCU 162 sends the trigger signal RX_0 to notify CPU 163 that the MCU 162 has started working. The CPU 163 then sends a test command to the graphics card 191, instructing the graphics card 191 to send display data to the display panel 170. Subsequently, the graphics card 191 transmits display data to the timing controller (TCON) 171 in the display panel 170 via an embedded DisplayPort (eDP), a high-speed digital video interface.

Step S200: The timing controller performs signal conversion on the display data, generating driving data, and then sends the driving data to the source driver.

Specifically, the timing controller (TCON) 171 converts the display data from eDP signals to Point-to-Point (P2P) signals.

Step S300: The source driver drives the pixel array to display an image according to the driving data.

Specifically, the TCON sends the P2P signals to the source driver (Source IC) 172, and the Source IC converts the digital signals into analog signals and outputs the analog signals to the pixel array 173 in the display panel 170, thereby achieving the corresponding image display.

Step S400: The ambient light detection circuit acquires the photosensitive voltage and the reference voltage corresponding to the current image.

Specifically, the ambient light detection circuit 100 acquires the photosensitive voltage and the reference voltage corresponding to the current image. The enable signal TE is set to match the cycle of the white and black images specified by the system. The ambient light detection circuit 100 sends the acquired voltage data to the MCU 162 for processing.

Step S500: The MCU obtains the light intensity based on the photosensitive voltage and the reference voltage, enabling the central processing unit to obtain a test result of the display panel according to the light intensity.

Specifically, the MCU 162 sends the obtained light intensity TX_1 to the CPU 163. The CPU 163 calculates optical parameters (such as response time, brightness uniformity, and color coordinates) based on the TX_1 data, and outputs a final test result.

The testing method in this embodiment may be applied to conventional notebooks, mobile phone screens, and home televisions, as well as potential fields such as medical equipment for self-detection when the required light intensity exceeds 1000 nits, or in gaming monitors for self-testing when the response time for high-frame-rate games is less than 5 ms. The present disclosure integrates the ambient light detection device into the display panel, greatly reducing the validation cycle for panel manufacturers, for parameters such as Gamma, color coordinates, delay time, and OD response time. Furthermore, since optical testing usually involves connecting different test devices to the computer (such as 410 or Photosensor), this approach eliminates the need for data cable interfaces to the upper computer system. Optical data conversion may be achieved simply by connecting the display interface (such as Type-C or HDMI), offering convenience, speed, and efficiency.

Additionally, the terms “first”, “second”, “third”, etc., are merely used for descriptive purposes and should not be construed as indicating or implying relative importance or specifying the number of technical features indicated. Therefore, features designated as “first”, “second”, or “third” may expressly or implicitly include one or more of such features. In the description of the present disclosure, “a plurality of” means two or more, unless otherwise specifically defined.

In the description of this specification, references to terms such as “some embodiments” or “exemplarily” mean that the specific features, structures, materials, or characteristics described in connection with that embodiment or example are included in at least one embodiment or example of the present disclosure. In this specification, the illustrative expressions regarding the above terms do not necessarily refer to the same embodiment or example. Moreover, the specific features, structures, materials, or characteristics described may be combined in any suitable manner in one or more embodiments or examples. Furthermore, those skilled in the art may combine and integrate different embodiments or examples and respective features thereof described in this specification without conflict.

Although the embodiments of the present disclosure have been shown and described above, it should be understood that these embodiments are exemplary and should not be construed as limiting the present disclosure. Those of ordinary skill in the art may make changes, modifications, substitutions, and alterations to the above embodiments within the scope of the present disclosure. Therefore, any changes or modifications made according to the claims and specification of the present disclosure should fall within the scope covered by the present patent disclosure.

What is claimed is:

1. An ambient light detection circuit, comprising:
a first driving module configured to generate a first driving voltage;
a photosensitive module, a first terminal of the photosensitive module being connected to a first connection terminal of the first driving module, and the photosensitive module being configured to generate a first photosensitive current corresponding to a current environment under an action of the first driving voltage;
a light-shielding module, a first terminal of the light-shielding module being connected to a second connection terminal of the first driving module, and the light-shielding module being configured to generate a first reference current corresponding to a black state environment under the action of the first driving voltage; and
a second driving module, a first connection terminal of the second driving module being connected to a second terminal of the photosensitive module, a second connection terminal of the second driving module being connected to a second terminal of the light-shielding module, and the second driving module being configured to generate a first photosensitive voltage and a first reference voltage corresponding to the first photosensitive current and the first reference current respectively based on the first photosensitive current and the first reference current, such that a subsequent-stage load obtains a light intensity corresponding to the current environment based on a difference between the first photosensitive voltage and the first reference voltage.

2. The ambient light detection circuit of claim 1, wherein the photosensitive module comprises:
a first photosensitive transistor, a control terminal of the first photosensitive transistor being connected to an external enable terminal, a first terminal of the first photosensitive transistor being connected to the first connection terminal of the first driving module, and a second terminal of the first photosensitive transistor being connected to the first connection terminal of the second driving module; and
the light-shielding module comprises:
a second photosensitive transistor, a control terminal of the second photosensitive transistor being connected to the external enable terminal, a first terminal of the second photosensitive transistor being connected to the second connection terminal of the first driving module, and a second terminal of the second photosensitive transistor being connected to the second connection terminal of the second driving module.

3. The ambient light detection circuit of claim 1, wherein the second driving module is further configured to generate a second driving voltage, such that the photosensitive module is further configured to generate a second photosensitive current corresponding to the current environment under an action of the second driving voltage, and the light-shielding module is further configured to generate a second reference current corresponding to the black state environment under the action of the second driving voltage;
wherein the first driving module is further configured to generate a second photosensitive voltage and a second reference voltage corresponding to the second photosensitive current and the second reference current respectively based on the second photosensitive current and the second reference current, such that the subsequent-stage load obtains a light intensity corresponding to the current environment based on a difference between the second photosensitive voltage and the second reference voltage.

4. The ambient light detection circuit of claim 3, wherein a control terminal of the photosensitive module is connected to an external enable terminal, and the photosensitive module is configured to generate a photosensitive current corresponding to the current environment based on the first driving voltage or the second driving voltage under a control of an enable signal output by the external enable terminal;
wherein a control terminal of the light-shielding module is connected to the external enable terminal, and the light-shielding module is configured to generate a reference current corresponding to the black state environment based on the first driving voltage or the second driving voltage under the control of the enable signal output by the external enable terminal.

5. The ambient light detection circuit of claim 3, wherein the first driving module comprises:
a first transistor, a control terminal of the first transistor being connected to a first power terminal, and a first terminal of the first transistor being connected to the control terminal of the first transistor;
a first resistor, a first terminal of the first resistor being connected to the first terminal of the first transistor, and a second terminal of the first resistor being connected to a second terminal of the first transistor;
a second transistor, a control terminal of the second transistor being connected to the first power terminal, and a first terminal of the second transistor being connected to the control terminal of the second transistor; and
a second resistor, a first terminal of the second resistor being connected to the first terminal of the second transistor, and a second terminal of the second resistor being connected to a second terminal of the second transistor;
wherein the second terminal of the first transistor serves as the first connection terminal of the first driving module, and the second terminal of the second transistor serves as the second connection terminal of the first driving module.

6. The ambient light detection circuit of claim 5, wherein the second driving module comprises:
a third transistor, a control terminal of the third transistor being connected to a second power terminal, and a first terminal of the third transistor being connected to the control terminal of the third transistor;
a third resistor, a first terminal of the third resistor being connected to the first terminal of the third transistor, and a second terminal of the third resistor being connected to a second terminal of the third transistor;
a fourth transistor, a control terminal of the fourth transistor being connected to the second power terminal, and a first terminal of the fourth transistor being connected to the control terminal of the fourth transistor; and
a fourth resistor, a first terminal of the fourth resistor being connected to the first terminal of the fourth transistor, and a second terminal of the fourth resistor being connected to a second terminal of the fourth transistor;
wherein the first terminal of the third transistor serves as the first connection terminal of the second driving module, and the first terminal of the fourth transistor serves as the second connection terminal of the second driving module.

7. The ambient light detection circuit of claim 6, further comprising:
an output module connected to the first driving module, the second driving module, and the subsequent-stage load, respectively, and configured to output at least one of the first photosensitive voltage or the second photosensitive voltage to the subsequent-stage load, and further configured to output at least one of the first reference voltage or the second reference voltage to the subsequent-stage load.

8. The ambient light detection circuit of claim 7, wherein the output module comprises:
a fifth transistor, a control terminal of the fifth transistor being connected to the second power terminal, and a first terminal of the fifth transistor being connected to the second terminal of the first transistor;
a sixth transistor, a control terminal of the sixth transistor being connected to the control terminal of the fifth transistor, and a first terminal of the sixth transistor being connected to the second terminal of the second transistor;
a seventh transistor, a control terminal of the seventh transistor being connected to the first power terminal, a first terminal of the seventh transistor being connected to the second terminal of the third transistor, and a second terminal of the seventh transistor being connected to a second terminal of the fifth transistor; and
an eighth transistor, a control terminal of the eighth transistor being connected to the control terminal of the seventh transistor, a first terminal of the eighth transistor being connected to the second terminal of the fourth transistor, and a second terminal of the eighth transistor is connected to a second terminal of the sixth transistor;
wherein the second terminal of the seventh transistor serves as a photosensitive voltage output terminal, configured to output the first photosensitive voltage and/or the second photosensitive voltage; and the second terminal of the eighth transistor serves as a reference voltage output terminal, configured to output the first reference voltage and/or the second reference voltage.

9. A display panel, comprising a display area and a non-display area, wherein the display area comprises a pixel array and an ambient light detection circuit;
wherein the ambient light detection circuit comprises:
a first driving module configured to generate a first driving voltage;
a photosensitive module, a first terminal of the photosensitive module being connected to a first connection terminal of the first driving module, and the photosensitive module being configured to generate a first photosensitive current corresponding to a current environment under an action of the first driving voltage;
a light-shielding module, a first terminal of the light-shielding module being connected to a second connection terminal of the first driving module, and the light-shielding module being configured to generate a first reference current corresponding to a black state environment under the action of the first driving voltage; and
a second driving module, a first connection terminal of the second driving module being connected to a second terminal of the photosensitive module, a second connection terminal of the second driving module being connected to a second terminal of the light-shielding module, and the second driving module being configured to generate a first photosensitive voltage and a first reference voltage corresponding to the first photosensitive current and the first reference current respectively based on the first photosensitive current and the first reference current, such that a subsequent-stage load obtains a light intensity corresponding to the current environment based on a difference between the first photosensitive voltage and the first reference voltage;
wherein the non-display area comprises a microcontroller unit, electrically connected to the ambient light detection circuit, configured to calculate a voltage difference between a photosensitive voltage and a reference voltage output by the ambient light detection circuit, and further configured to obtain the light intensity corresponding to the current environment based on the voltage difference.

10. The display panel of claim 9, wherein the photosensitive module comprises:
a first photosensitive transistor, a control terminal of the first photosensitive transistor being connected to an external enable terminal, a first terminal of the first photosensitive transistor being connected to the first connection terminal of the first driving module, and a second terminal of the first photosensitive transistor being connected to the first connection terminal of the second driving module; and
the light-shielding module comprises:
a second photosensitive transistor, a control terminal of the second photosensitive transistor being connected to the external enable terminal, a first terminal of the second photosensitive transistor being connected to the second connection terminal of the first driving module, and a second terminal of the second photosensitive transistor being connected to the second connection terminal of the second driving module.

11. The display panel of claim 9, wherein the second driving module is further configured to generate a second driving voltage, such that the photosensitive module is further configured to generate a second photosensitive current corresponding to the current environment under an action of the second driving voltage, and the light-shielding module is further configured to generate a second reference current corresponding to the black state environment under the action of the second driving voltage;
wherein the first driving module is further configured to generate a second photosensitive voltage and a second reference voltage corresponding to the second photosensitive current and the second reference current respectively based on the second photosensitive current and the second reference current, such that the subsequent-stage load obtains a light intensity corresponding to the current environment based on a difference between the second photosensitive voltage and the second reference voltage.

12. The display panel of claim 11, wherein a control terminal of the photosensitive module is connected to an external enable terminal, and the photosensitive module is configured to generate a photosensitive current corresponding to the current environment based on the first driving voltage or the second driving voltage under a control of an enable signal output by the external enable terminal;
wherein a control terminal of the light-shielding module is connected to the external enable terminal, and the light-shielding module is configured to generate a reference current corresponding to the black state environment based on the first driving voltage or the second driving voltage under the control of the enable signal output by the external enable terminal.

13. The display panel of claim 11, wherein the first driving module comprises:
a first transistor, a control terminal of the first transistor being connected to a first power terminal, and a first terminal of the first transistor being connected to the control terminal of the first transistor;
a first resistor, a first terminal of the first resistor being connected to the first terminal of the first transistor, and a second terminal of the first resistor being connected to a second terminal of the first transistor;
a second transistor, a control terminal of the second transistor being connected to the first power terminal, and a first terminal of the second transistor being connected to the control terminal of the second transistor; and
a second resistor, a first terminal of the second resistor being connected to the first terminal of the second transistor, and a second terminal of the second resistor being connected to a second terminal of the second transistor;
wherein the second terminal of the first transistor serves as the first connection terminal of the first driving module, and the second terminal of the second transistor serves as the second connection terminal of the first driving module.

14. The display panel of claim 13, wherein the second driving module comprises:
a third transistor, a control terminal of the third transistor being connected to a second power terminal, and a first terminal of the third transistor being connected to the control terminal of the third transistor;
a third resistor, a first terminal of the third resistor being connected to the first terminal of the third transistor, and a second terminal of the third resistor being connected to a second terminal of the third transistor;
a fourth transistor, a control terminal of the fourth transistor being connected to the second power terminal, and a first terminal of the fourth transistor being connected to the control terminal of the fourth transistor; and
a fourth resistor, a first terminal of the fourth resistor being connected to the first terminal of the fourth transistor, and a second terminal of the fourth resistor being connected to a second terminal of the fourth transistor;
wherein the first terminal of the third transistor serves as the first connection terminal of the second driving module, and the first terminal of the fourth transistor serves as the second connection terminal of the second driving module.

15. The display panel of claim 14, wherein the ambient light detection circuit further comprises:
an output module connected to the first driving module, the second driving module, and the subsequent-stage load, respectively, and configured to output at least one of the first photosensitive voltage or the second photosensitive voltage to the subsequent-stage load, and further configured to output at least one of the first reference voltage or the second reference voltage to the subsequent-stage load.

16. The display panel of claim 15, wherein the output module comprises:
a fifth transistor, a control terminal of the fifth transistor being connected to the second power terminal, and a first terminal of the fifth transistor being connected to the second terminal of the first transistor;
a sixth transistor, a control terminal of the sixth transistor being connected to the control terminal of the fifth transistor, and a first terminal of the sixth transistor being connected to the second terminal of the second transistor;
a seventh transistor, a control terminal of the seventh transistor being connected to the first power terminal, a first terminal of the seventh transistor being connected to the second terminal of the third transistor, and a second terminal of the seventh transistor being connected to a second terminal of the fifth transistor; and
an eighth transistor, a control terminal of the eighth transistor being connected to the control terminal of the seventh transistor, a first terminal of the eighth transistor being connected to the second terminal of the fourth transistor, and a second terminal of the eighth transistor is connected to a second terminal of the sixth transistor;
wherein the second terminal of the seventh transistor serves as a photosensitive voltage output terminal, configured to output the first photosensitive voltage and/or the second photosensitive voltage; and the second terminal of the eighth transistor serves as a reference voltage output terminal, configured to output the first reference voltage and/or the second reference voltage.

17. A display panel testing method, applied to a display panel testing system, the display panel testing system comprising an upper computer and a display panel, the upper computer comprising a central processing unit and a graphics card, and the display panel comprising a display area and a non-display area, wherein the display area comprises a pixel array and an ambient light detection circuit;
wherein the ambient light detection circuit comprises:
a first driving module configured to generate a first driving voltage;
a photosensitive module, a first terminal of the photosensitive module being connected to a first connection terminal of the first driving module, and the photosensitive module being configured to generate a first photosensitive current corresponding to a current environment under an action of the first driving voltage;
a light-shielding module, a first terminal of the light-shielding module being connected to a second connection terminal of the first driving module, and the light-shielding module being configured to generate a first reference current corresponding to a black state environment under the action of the first driving voltage; and
a second driving module, a first connection terminal of the second driving module being connected to a second terminal of the photosensitive module, a second connection terminal of the second driving module being connected to a second terminal of the light-shielding module, and the second driving module being configured to generate a first photosensitive voltage and a first reference voltage corresponding to the first photosensitive current and the first reference current respectively based on the first photosensitive current and the first reference current, such that a subsequent-stage load obtains a light intensity corresponding to the current environment based on a difference between the first photosensitive voltage and the first reference voltage;
wherein the non-display area comprises a microcontroller unit, electrically connected to the ambient light detection circuit, configured to calculate a voltage difference between a photosensitive voltage and a reference voltage output by the ambient light detection circuit, and further configured to obtain the light intensity corresponding to the current environment based on the voltage difference;
wherein the display panel further comprises a timing controller and a source driver, the microcontroller unit being electrically connected to the central processing unit, the central processing unit being further electrically connected to the graphics card, the graphics card being connected to the timing controller, the timing controller being connected to the source driver, and the source driver being electrically connected to the pixel array;
wherein the display panel testing method comprises:
upon receiving a trigger signal sent by the microcontroller unit, sending, by the central processing unit, a test instruction to the graphics card, causing the graphics card to send display data to the timing controller;
performing, by the timing controller, signal conversion on the display data, generating driving data, and then sending the driving data to the source driver;
driving, by the source driver, the pixel array to display an image based on the driving data;
acquiring, by the ambient light detection circuit, the photosensitive voltage and the reference voltage corresponding to the image; and
obtaining, by the microcontroller unit, the light intensity based on the photosensitive voltage and the reference voltage, enabling the central processing unit to obtain a test result of the display panel based on the light intensity.

18. The display panel testing method of claim 17, wherein the photosensitive module comprises:
a first photosensitive transistor, a control terminal of the first photosensitive transistor being connected to an external enable terminal, a first terminal of the first photosensitive transistor being connected to the first connection terminal of the first driving module, and a second terminal of the first photosensitive transistor being connected to the first connection terminal of the second driving module; and
the light-shielding module comprises:
a second photosensitive transistor, a control terminal of the second photosensitive transistor being connected to the external enable terminal, a first terminal of the second photosensitive transistor being connected to the second connection terminal of the first driving module, and a second terminal of the second photosensitive transistor being connected to the second connection terminal of the second driving module.

19. The display panel testing method of claim 17, wherein the second driving module is further configured to generate a second driving voltage, such that the photosensitive module is further configured to generate a second photosensitive current corresponding to the current environment under an action of the second driving voltage, and the light-shielding module is further configured to generate a second reference current corresponding to the black state environment under the action of the second driving voltage;
wherein the first driving module is further configured to generate a second photosensitive voltage and a second reference voltage corresponding to the second photosensitive current and the second reference current respectively based on the second photosensitive current and the second reference current, such that the subsequent-stage load obtains a light intensity corresponding to the current environment based on a difference between the second photosensitive voltage and the second reference voltage.

20. The display panel testing method of claim 19, wherein a control terminal of the photosensitive module is connected to an external enable terminal, and the photosensitive module is configured to generate a photosensitive current corresponding to the current environment based on the first driving voltage or the second driving voltage under a control of an enable signal output by the external enable terminal;
wherein a control terminal of the light-shielding module is connected to the external enable terminal, and the light-shielding module is configured to generate a reference current corresponding to the black state environment based on the first driving voltage or the second driving voltage under the control of the enable signal output by the external enable terminal.
